(19) United States
(12) Patent Application Publication
(10) Pub. No.: US 2018/0037196 A1
(43) Pub. Date: Feb. 8, 2018

(54) WINDSCREEN WIPER DEVICE

(71) Applicant: Federal-Mogul Motorparts Corporation, Southfield, MI (US)

(72) Inventors: Jesus Yee, El Paso, TX (US); Dennis E. Cox, Belleville, MI (US); Miguel Gutierrez, Ciudad Juarez (MX)

(21) Appl. No.: 15/632,495

(22) Filed: Jun. 26, 2017

Related U.S. Application Data
(60) Provisional application No. 62/371,074, filed on Aug. 4, 2016.

(51) Int. Cl. B60S 1/34

(52) U.S. Cl. CPC B60S 1/3452; B60S 1/3436; B60S 1/3431; B60S 1/3425; B29C 45/00

(57) ABSTRACT

The windscreen wiper device includes a wiper blade that extends lengthwise in a longitudinal direction. A pre-curved carrier element with opposing lateral edges biases the wiper blade into a curved shape. At least one projection of a connector base is received in at least one notch of the carrier element for restricting relative longitudinal movement between the connector base and the carrier element. The connector base also at least one long locking arm and at least one short locking arm which engage around the lateral edges of the carrier element to lockingly connect the connector base with the carrier element. The at least one short locking arm has a lateral width which is less than the at least one long locking arm. The at least one short locking arm has a ramped lower surface for allowing the at least one short locking arm to snappingly engage the carrier element.

### CROSS-REFERENCE TO RELATED APPLICATION

This application claims the benefit of U.S. Provisional Patent Application Ser. No. 62/371,074, filed Aug. 4, 2016, entitled “Windscreen Wiper Device”, the entire disclosure of the application being considered part of the disclosure of this application and hereby incorporated by reference.

### BACKGROUND OF THE INVENTION

### 1. Field of the Invention

The present invention is related, generally, to windscreen wiper devices and port particularly to the connecting devices of windscreen wiper devices.

### 2. Related Art

Wiper devices typically fall into one of three basic categories: conventional, beam and hybrid. Conventional blades utilize a frame structure which consists of a system of yokes arranged in a tournament-style construction to distribute a biasing force from an oscillating wiper arm across a length of an elastomeric wiper blade. Beam blades utilize a carrier element, which typically includes one or more longitudinal strips of spring steel, to distribute the biasing force along the length of the wiper strip. Hybrid blades typically include both a frame structure and a carrier element to distribute the biasing force from the wiper arm.

In beam blades, a connecting device is attached directly to the carrier element. In some cases, the connecting device is glued/bonded with the carrier element, and in others, the connecting device is ultrasonically welded with the carrier element.

### SUMMARY OF THE INVENTION AND ADVANTAGES

One aspect of the present invention is related to a windscreen wiper device which includes a wiper blade that is made of an elastomeric material and that extends lengthwise in a longitudinal direction. The wiper device also includes a carrier element which is pre-curved to have a curved shape when in a relaxed condition. The carrier element operatively supports the wiper blade and biases the wiper blade into a curved shape. The carrier element has a pair of opposing lateral edges, and at least one of the lateral edges has a notched formed into it. A connector base is operably connected with the carrier element. The base includes at least one projection which is received in the at least one notch of the carrier element for restricting relative movement between the connector base and the carrier element in the longitudinal direction. The connector base also includes a plurality of locking arms which engage around the lateral edges of the carrier element to lockingly connect the connector base with the carrier element. The plurality of locking arms includes at least one long locking arm on one lateral side of the connector base and includes at least one short locking arm on an opposite lateral side of the connector base form the at least one long locking arm. The at least one short locking arm has a lateral width which is less than the at least one long locking arm. The at least one short locking arm has a ramped lower surface for allowing the at least one short locking arm to snappingly engage the carrier element.

The wiper device according to this embodiment advantageously allows the connector base to be more quickly, simply and firmly secured with the carrier element in a cost effective manner.

According to another aspect of the present invention, the connector base includes at least two short locking arms and at least two long locking arms.

According to yet another aspect of the present invention, the carrier element includes at least one notched formed into each of the lateral edges, and the connector base includes a pair of projections which are received into the notches.

According to still another aspect of the present invention, the at least two locking arms are located on opposite longitudinal sides of one of the projections, and the at least two short locking arms are located on opposite longitudinal sides of another of the projections.

According to a further aspect of the present invention, each of the long legs has an upper surface with a curved end for allowing the base to be rotated relative to the carrier element during installation of the base onto the carrier element to snappingly engage the short locking arms with the carrier element.

According to yet a further aspect of the present invention, the connector base is made of a single piece of injection molded plastic.

According to still a further aspect of the present invention, a joint part is pivotably connected with the connector base.

Another aspect of the present invention is related to a method of making a windscreen wiper device. The method includes the step of operably connecting a pre-curved carrier element that has opposing lateral edges with notches formed therein with an elastomeric wiper blade to bias the wiper blade into a curved shape. The method continues with the step of preparing a connector which includes a base that has a bottom wall with at least one projection formed therein and also has at least one short locking arm that extends from one lateral side of the bottom wall and at least one long locking arm that extends from an opposite lateral side of the bottom wall. The at least one short locking arm has a ramped lower surface. The method proceeds with the step of inserting one lateral edge of the carrier element into a gap between the at least one long locking arm and the bottom wall of the base rotating the base relative to the carrier element until the ramped surface of the at least one short locking arm contacts an opposite lateral edge of the carrier element. The method continues with the step of flexing the base by continued rotation of the base relative to the carrier element. The method proceeds with the step of snappingly engaging the at least one short locking arm of the base around an opposite lateral edge of the carrier element from the at least one long locking arm. The method continues with the step of receiving the at least one projection in the at least one notch of the carrier element.

According to another aspect of the present invention, the base of the connector is made as a single piece of injection molded plastic.

According to yet another aspect of the present invention, the at least one long locking arm includes a chamfered distal end for facilitating the rotation of the base relative to the carrier element.

According to still another aspect of the present invention, the carrier element includes a pair of longitudinal strips.

According to a further aspect of the present invention, the carrier element includes a pair of notches, and the base includes a pair of projections.

According to yet a further aspect of the present invention, the base includes a pair of short locking arms and a pair of long locking arms.

According to still a further aspect of the present invention, the short locking arms are located on opposite longitudinal sides of one of the projections and the long locking arms are located on opposite longitudinal sides of the other of the projections.

### BRIEF DESCRIPTION OF THE DRAWINGS

These and other aspect, features and advantages of the invention will become more readily appreciated when considered in connection with the following detailed description of the presently preferred embodiment and best mode, appended claims and accompanying drawings, in which:

FIG. 1 is a perspective elevation view of an exemplary embodiment of a windscreen wiper device constructed in accordance with one aspect of the present invention;

FIG. 2 is a fragmentary and enlarged view of a portion of the wiper device of FIG. 1;

FIG. 3 is a fragmentary and perspective elevation view of an underside of a portion of the wiper device of FIG. 1;

FIG. 4 is a fragmentary and perspective elevation view of a carrier element and a wiper blade of the wiper device of FIG. 1;

FIG. 5 is a perspective and elevation view of a base of a connector of the wiper device of FIG. 1;

FIG. 6 is a fragmentary and bottom elevation view of the wiper device of FIG. 1;

FIG. 7 is a cross-sectional view of the wiper device taken through Line 7-7 of FIG. 6;

FIG. 8 is a cross-sectional view of the wiper device taken through Line 8-8 of FIG. 6; and

FIG. 9 is a cross-sectional view of the wiper device of FIG. 1 showing the connector base being attached with the longitudinal strips.

### DETAILED DESCRIPTION OF THE ENABLING EMBODIMENT

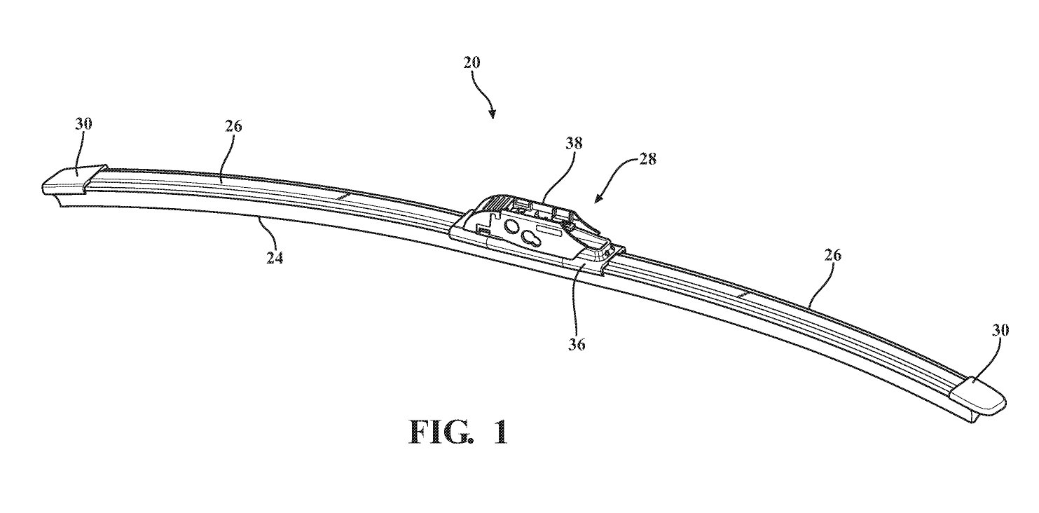

Referring to the Figures, wherein like numerals indicate corresponding parts throughout the several views, an exemplary embodiment of a windscreen wiper device 20 is generally shown in FIG. 1. The windscreen wiper device 20 has a beam-style construction in that it includes a carrier element 22 (shown in FIGS. 3 and 4) which extends lengthwise in a longitudinal direction and is pre-shaped to bias a wiper blade 24 that is made of an elastomeric material, such as rubber, into a curved shape. The curved shape of the wiper blade 24 allows its entire length to be sealed and remain sealed against a curved windshield (not shown) of a vehicle as the windscreen wiper device 20 oscillates back and forth across the windshield. That is, in the exemplary windscreen wiper device 20, the pre-curved carrier element 22, rather than a series of yokes, distributes a force from an oscillating wiper arm (not shown) across the length of the wiper blade 24.

The exemplary windscreen wiper device 20 also includes a pair of covers 26, which are made as separate pieces from one another and are attached with the carrier element 22. Although they are not in the exemplary embodiment, the covers 26 may be shaped to impart a downforce on the wiper blade 24 when the vehicle is travelling at speed to improve the fluid-tight seal between the wiper blade 24 and the windshield. A connector 28 is engaged with the carrier element 22 at approximately a longitudinal midpoint of the carrier element 22 and between the covers 26 for lockingly connecting the windscreen wiper device 20 with an oscillating wiper arm (not shown). A pair of end caps 30 are engaged with opposite ends of the carrier element 22 for retaining the covers 26 on the carrier element 22 between the connector 28 and the end caps 30. As shown in FIGS. 3 and 4, in the exemplary embodiment, the carrier element 22 includes a pair of longitudinal strips 22 (also known as flexors) that are made of spring steel and that are received in longitudinally extending grooves of the wiper blade 24. However, it should be appreciated that the carrier element could take other forms, e.g., the carrier element could be a single longitudinal strip that is glued to the wiper strip or it could be a single longitudinal strip that is received within a single longitudinal groove of a one-piece wiper strip and spoiler.

Referring now to FIG. 4, each of the longitudinal strips 22 has an outwardly facing lateral edge 32 which extends in the longitudinal direction along the length of the respective longitudinal strip 22. The laterally outwardly facing edges 32 are provided with notches 34, or recesses, formed therein at approximately their respective longitudinal midpoints such that the notches 34 are longitudinally aligned with one another.

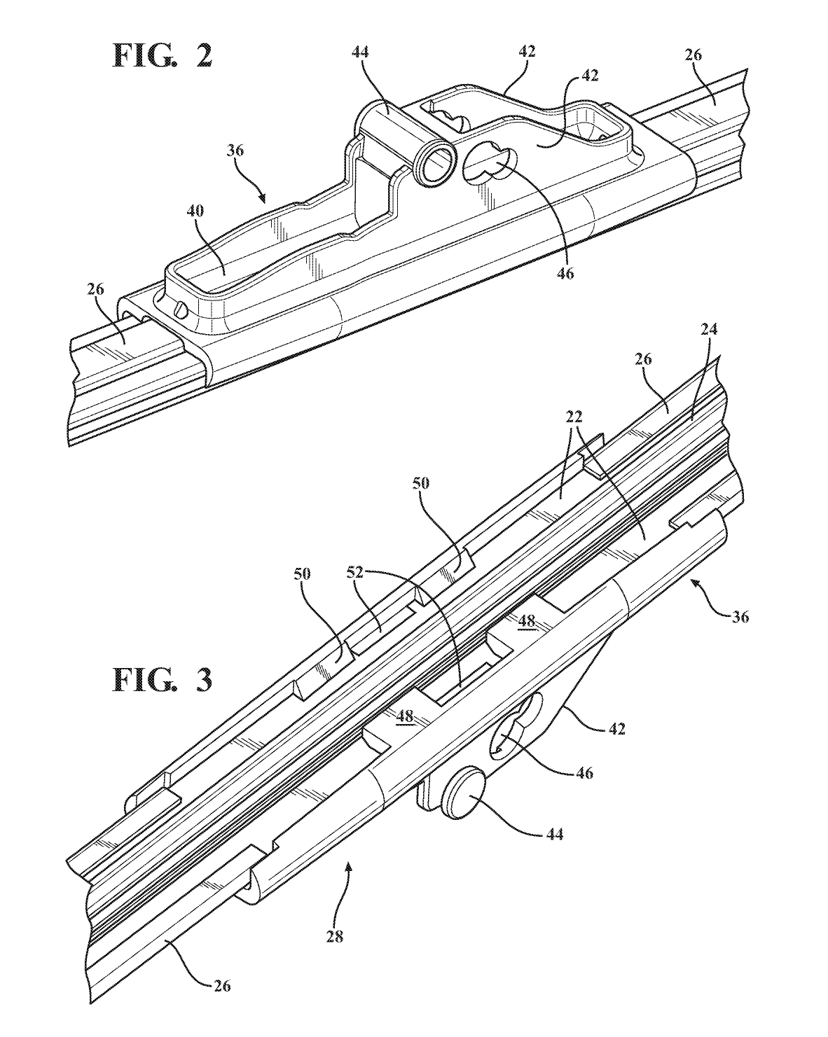

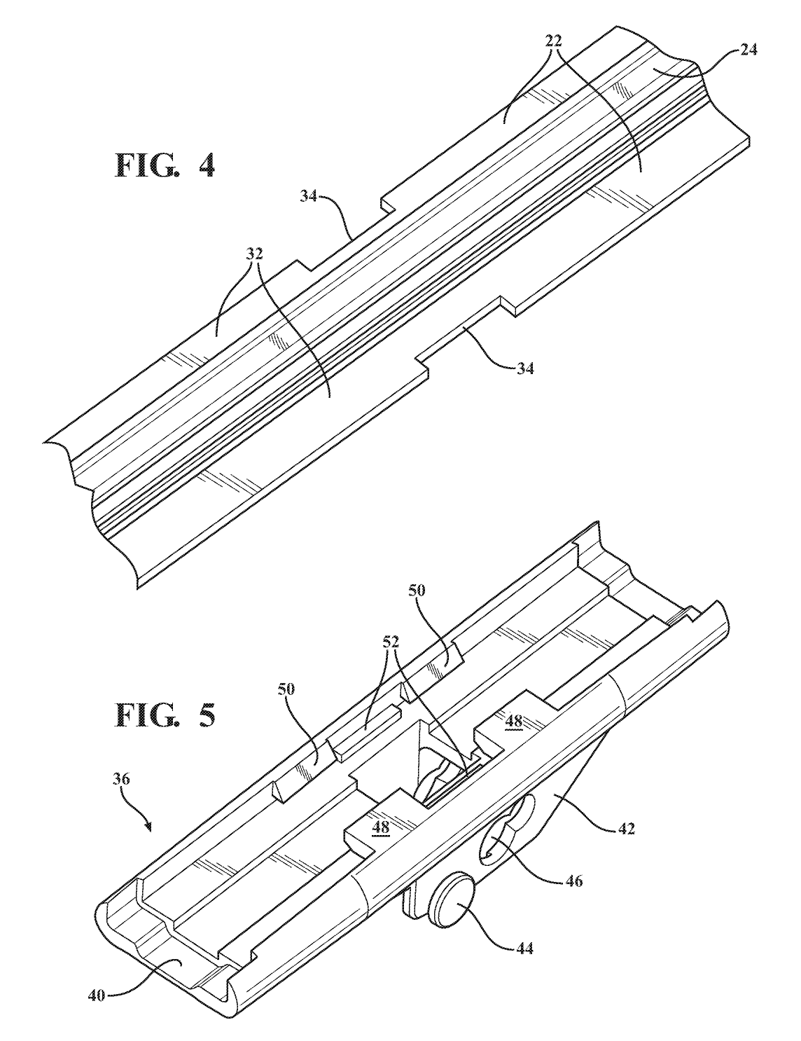

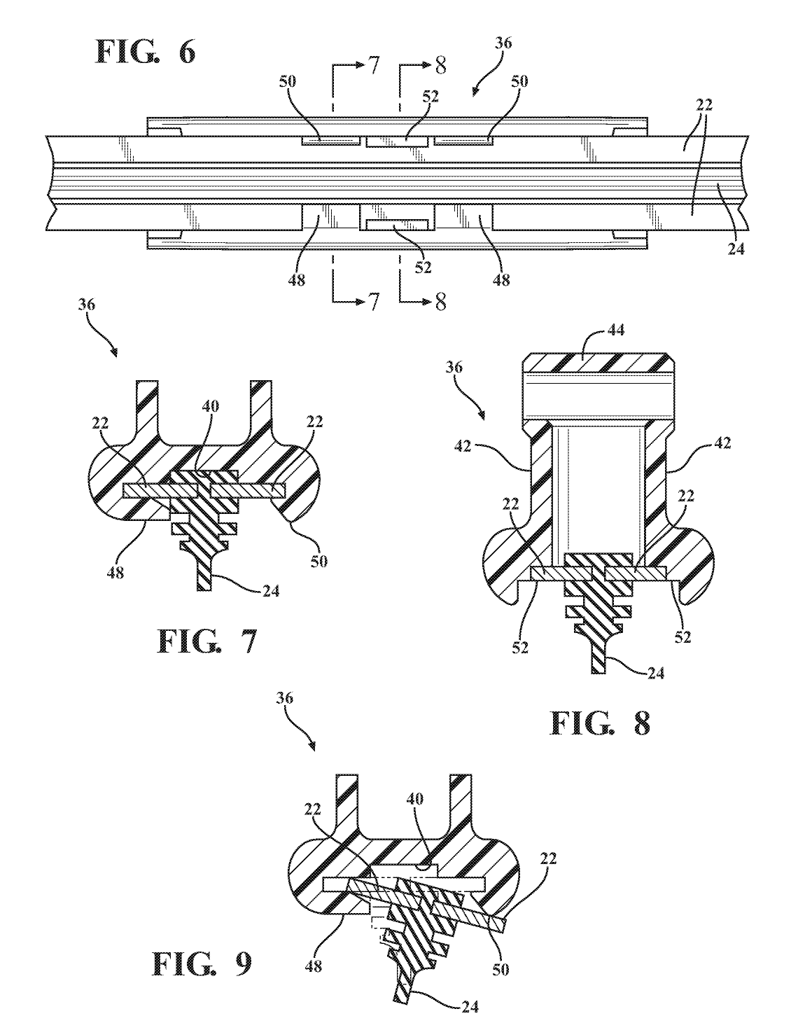

Referring now to FIGS. 1-3, the connector 28 of the exemplary windscreen wiper device 20 includes a base 36 which is fixed with the longitudinal strips 22 and a joint part 38 which is pivotably connected with the base 36. The exemplary joint part 38 is configured for attachment with bayonet-style and top lock-style oscillating wiper arms (not show) but may take any suitable shape for attachment with any suitable type of oscillating wiper arm. The pivoting connection between the base 36 and the joint part 38 allows the joint part 38 to be pivoted about a pivot axis relative to the base 36 when attaching the windscreen wiper device 20 with or detaching the windscreen wiper device 20 from an oscillating wiper arm.

The base 36 is made as a single piece of injection molded plastic and has a bottom wall 40 and a pair of side walls 42 that extend vertically upwardly from the bottom wall 40. The side walls 42 are spaced from one another in a lateral direction and extend parallel to one another. A cylindrically shaped pin 44 is supported by the side walls 42 and extends in a lateral direction past each of the side walls 42. The joint part 38 includes a pair of co-axial and circular-shaped openings which receive the pin 44 to establish the pivoting connection between the joint part 38 and the base 36. The side walls 42 also present a pair of co-axially aligned windows 46 for receiving a side pin (not shown) to allow the connector to be attached with a side pin-style oscillating wiper arm (not shown).

As shown in FIG. 3, the underside of the base 36 includes a plurality of locking arms 48, 50 and a pair of projections 52 which cooperate with the longitudinal strips 22 to operably secure the connector 28 with the longitudinal strips 22. The projections 52 are generally shelf-like in shape and are shaped similarly to the notches 34 in the longitudinal strips 22. The projections 52 extend vertically downwardly from a lower surface of the bottom wall 40. As shown, when the base 36 is connected with the longitudinal strips 22, longitudinal end surfaces on the projections 52 abut corresponding edges of the longitudinal strips 22 to restrict relative movement between the base 36 and the longitudinal strips 22. The locking arms 48, 50 wrap around the opposite lateral edges 32 of the longitudinal strips 22 to hold the base 36 with the longitudinal strips 22 and to hold the projections 52 in the notches 34. Accordingly, the locking arms 48, 50 hold the base 36 on the longitudinal strips 22, and the projections 52 restrict relative movement between the base 36 and the longitudinal strips 22.

In the exemplary embodiment, the base 36 has two projections 52 which are positioned on opposite lateral sides of the underside of the bottom wall 40 and are generally aligned with one another in the longitudinal direction at approximately a longitudinal midpoint of the base 36. The exemplary embodiment of the base 36 also includes a total of four locking arms 48, 50, which includes a pair of long locking arms 48 on one lateral side of the base 36 for engaging one of the longitudinal strips 22 and a pair of short locking arms 50 on an opposite lateral side of the base 36 for engaging the other of the longitudinal strips 22. In the longitudinal direction, the two long locking arms 48 are located on opposite sides of one of the projections 52 and the two short locking arms 50 are located on opposite sides of the other projection. In the exemplary embodiment, the long and short locking arms 48, 50 are spaced from opposite longitudinal ends of the base 36.

As shown in FIG. 7, the long locking arms 48 have a greater width in the lateral direction than the short locking arms 50. The distal ends of the long locking arms 48 are curved or chamfered downwardly (away from the longitudinal strips), and the short locking arms 50 have ramped lower surfaces.

Another aspect of the present invention is related to a method of making a windscreen wiper device 20, such as the windscreen wiper device shown in FIG. 1. The method includes the step of inserting the longitudinal strips 22 of the carrier element 22 into opposing longitudinal grooves of the elastomeric wiper blade 24 to bias the wiper blade 24 into a curved shape. The method continues with the steps of preparing the connector 28 and inserting one lateral edge 32 of one of the longitudinal strips 22 into the gaps between the long locking arms 48 and the bottom wall 40 of the base 36 such that the projection 52 between the long locking arms 48 is received into the notch 34 of the longitudinal strip 22. As shown in FIG. 9, the method proceeds with the step of rotating the base 36 relative to the longitudinal strips 22 until the ramped surfaces of the short locking arms 50 contact the lateral edge 32 of the other longitudinal strip 22. The method continues with the step of elastically flexing the base 36 by continued rotation of the base 36 relative to the longitudinal strips 22. This flexing automatically occurs due to the ramped surfaces of the short locking arms 50. The method proceeds with the steps of snappingly engaging the short locking arms 50 of the base 36 around the opposite longitudinal strip 22 and receiving the projection 52 between the short locking arms 50 into the notch 34 of the longitudinal strip 22 connected therewith. The joint part 38 can be connected with the base 36 either before or after the base 36 is attached with the longitudinal strips 22.

The resulting engagement between the base 36 and the longitudinal strips 22 does not involve the use of any of the adhesives, welding, fasteners or separate locking means that are commonly employed to attach a connector base with a longitudinal strip in a beam style wiper blade. Additionally, unlike other known wiper devices, the base does not have to be slid longitudinally from one end of the carrier element into its location. The joint part 38 may be coupled with the base 36 either before or after attaching the base 36 with the longitudinal strips 22.

Obviously, many modifications and variations of the present invention are possible in light of the above teachings. It is, therefore, to be understood that within the scope of the appended claims, the invention may be practiced otherwise than specifically described. It should also be appreciated that the directional terms such as “upper”, “lower”, “top” and “bottom” are in reference to the orientations of the enabling embodiment of the invention shown in the Figures and are not meant to require any certain orientation. Additionally, it is to be understood that all features of all claims and all embodiments can be combined with each other, as long as they do not contradict each other.

What is claimed is:

1. A windscreen wiper device, comprising:
a wiper blade made of an elastomeric material and extending in a longitudinal direction;
a carrier element that is pre-curved to have a curved shape when in a relaxed condition and operatively supporting said wiper blade and biasing said wiper blade into a curved shape;
said carrier element having opposing lateral edges, at least one of said lateral edges having a notch formed therein;
a connector base operably connected with said carrier element and including at least one projection received in said at least one notch of said carrier element for restricting relative movement between said connector base and said carrier element in said longitudinal direction;
said connector base further including a plurality of locking arms which engage around said lateral edges of said carrier element to lockingly connect said connector base with said carrier element;
said plurality of locking arms including at least one long locking arm on one lateral side of said connector base and at least one short locking arms on an opposite lateral side of said connector base from said at least one long locking arm, said at least one short locking arm having a lateral width that is less than said at least one long locking arm; and
said at least one short locking arm having ramped lower surfaces for allowing said at least one short locking arm to snappingly engage said carrier element.

2. The windscreen wiper device as set forth in claim 1 wherein said connector base includes at least two short locking arms and at least two long locking arms.

3. The windscreen wiper device as set forth in claim 2 wherein said carrier element includes at least one notched formed into each of said lateral edges and wherein said connector base includes a pair of projections which are received in said notches.

4. The windscreen wiper device as set forth in claim 3 wherein said at least two long locking arms are located on opposite longitudinal sides of one of said projections and wherein said at least two short locking arms are located on opposite longitudinal sides of another of said projections.

5. The windscreen wiper device as set forth in claim 2 wherein each of said long legs has an upper surface with a curved end for allowing said base to be rotated relative to said carrier element during installation of said base onto said carrier element to snappingly engage said short locking arms with said carrier element.

6. The windscreen wiper device as set forth in claim 1 wherein said connector base is made of a single piece of injection molded plastic.

7. The windscreen wiper device as set forth in claim 1 wherein said carrier element includes a pair of longitudinal strips which are received in opposing longitudinal grooves in said wiper blade.

8. The windscreen wiper device as set forth in claim 1 further including a joint part which is pivotably connected with said connector base.

9. A method of making a windscreen wiper device, comprising the steps of:
operably connecting a pre-curved carrier element that has opposing lateral edges with notches formed therein with an elastomeric wiper blade to bias the wiper blade into a curved shape;
preparing a connector which includes a base that has a bottom wall with at least one projection formed therein and that has at least one short locking arm extending from one lateral side of the bottom wall and at least one long locking arm extending from an opposite lateral side of the bottom wall and wherein the at least one short locking arm has a ramped lower surface;
inserting one lateral edge of the carrier element into a gap between the at least one long locking arm and the bottom wall of the base;
rotating the base relative to the carrier element until the ramped surface of the at least one short locking arm contacts an opposite lateral edge of the carrier element;
flexing the base by continued rotation of the base relative to the carrier element;
snappingly engaging the at least one short locking arm of the base around an opposite lateral edge of the carrier element from the at least one long locking arm; and
receiving the at least one projection in the at least one notch of the carrier element.

10. The method as set forth in claim 9 wherein the base of the connector is made as a single piece of injection molded plastic.

11. The method as set forth in claim 10 wherein an upper surface of the at least one long locking arm includes a chamfered or curved distal end for facilitating the rotation of the base relative to the carrier element.

12. The method as set forth in claim 9 wherein the carrier element includes a pair of longitudinal strips.

13. The method as set forth in claim 9 wherein the carrier element includes a pair of notches and the base includes a pair of projections.

14. The method as set forth in claim 13 wherein the base includes a pair of short locking arms and a pair of long locking arms.

15. The method as set forth in claim 14 wherein the short locking arms are located on opposite longitudinal sides of one of the projections and the long locking arms are located on opposite longitudinal sides of the other of the projections.
